(19) United States
(12) Patent Application Publication
(10) Pub. No.: US 2020/0285325 A1
(43) Pub. Date: Sep. 10, 2020

(54) DETECTING TILT OF AN INPUT DEVICE TO IDENTIFY A PLANE FOR CURSOR MOVEMENT

(71) Applicant: Hewlett-Packard Development Company, L.P., Spring, TX (US)

(72) Inventors: Ian N Robinson, Palo Alto, CA (US); Hiroshi Horii, Palo Alto, CA (US)

(73) Assignee: Hewlett-Packard Development Company, L.P., Spring, TX (US)

(21) Appl. No.: 16/618,546

(22) PCT Filed: Oct. 24, 2017
(86) PCT No.: PCT/US2017/058056

§ 371 Date: Dec. 2, 2019

(51) Int. Cl. G06F 3/0346; G06F 3/0354

(52) U.S. Cl. CPC G06F 3/0346; G06F 3/0354

(57) ABSTRACT

A method includes detecting a tilt of at least a portion of an input device, wherein the input device enables a user to move a displayed cursor in three-dimensional (3D) space. The method further includes identifying a plane in the 3D space based on the detected tilt, and causing movement of the cursor within the identified plane based on translational movement of the input device.

### BACKGROUND

Input devices such as a controller, a mouse, a touchpad, a pointing stick, a touchscreen, a joy stick, and a trackball, among others, may be used to control the movement of on-screen position identifiers such as cursors or pointers. Further, input devices may be used to move objects on the screen, or perform other selection and positional processes with regard to objects displayed on a display device.

### BRIEF DESCRIPTION OF THE DRAWINGS

FIG. 1 is a block diagram illustrating a computing system with a rocking input device according to one example.

FIG. 2A is a diagram illustrating one view of a two-position rocking input device according to one example.

FIG. 2B is a diagram illustrating another view of the two-position rocking input device shown in FIG. 2A according to one example.

FIGS. 3A and 3B are diagrams illustrating the use of the input device shown in FIGS. 2A and 2B to control cursor movement according to one example.

FIG. 4 is a diagram illustrating one view of a multi-plane rocking input device according to one example.

FIG. 5 is a diagram illustrating another view of the multi-plane rocking input device shown in FIG. 4 according to one example.

FIG. 6 is a diagram illustrating the use of the input device shown in FIGS. 4 and 5 to control cursor movement according to one example.

FIG. 7 is a diagram illustrating the use of the input device shown in FIGS. 4 and 5 to control cursor movement according to another example.

FIG. 8 is a diagram illustrating the use of the input device shown in FIGS. 4 and 5 to control cursor movement according to yet another example.

FIG. 9A is a diagram illustrating one view of a six degree of freedom (6DOF) two-position rocking input device according to one example.

FIG. 9B is a diagram illustrating another view of the 6DOF two-position rocking input device shown in FIG. 9A according to one example.

FIG. 10A is a diagram illustrating one view of a 6DOF multi-plane rocking input device according to one example.

FIG. 10B is a diagram illustrating another view of the 6DOF multi-plane rocking input device shown in FIG. 10A according to one example.

FIG. 11 is a diagram illustrating the 6DOF multi-plane rocking input device shown in FIGS. 10A and 10B with the outer shell removed according to one example.

FIG. 12 is a diagram illustrating an input device with a paddle-like lever for identifying a plane for cursor motion according to one example.

FIG. 13 is a flow diagram illustrating a method of controlling movement of a displayed cursor with an input device according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

This disclosure is directed to a mouse-like input device (e.g., a mouse) that enables a user to select a plane in which a displayed cursor is to move in three-dimensional (3D) space based on a tilt (e.g., forward-backward) of the input device. Because the mouse-like input device is able to tilt or rock forward and backward, some examples disclosed herein may be referred to as a “tilting mouse” or “rocking mouse”. The three degrees of freedom (3DOF) translational input method disclosed herein may be combined with other controls, such as a 3DOF rotational control, to create a six degrees of freedom (6DOF) control device. The input device may be designed in such a way that while the user is holding the device and using the controls available on its surface (e.g., mouse buttons), the device can be rocked backwards and forwards. The orientation the user selects via this rocking motion controls the plane in which the cursor moves in 3D space.

With 3D computer-aided design (CAD), virtual reality (VR), augmented reality (AR), and mixed reality, there are an increasing number of applications, particularly applications relevant to workstations, which could benefit from intuitive and precise manipulation in 3D space. Some examples disclosed herein use a mouse-like device to support this, which has the following added benefits: (1) The input device is mostly familiar; (2) 3D input can be realized without the user lifting their hand from the desktop surface (which can be tiring after long periods); and (3) Mouse-like actions on a two-dimensional (2D) surface may be achieved with more precision than actions performed in 3D space.

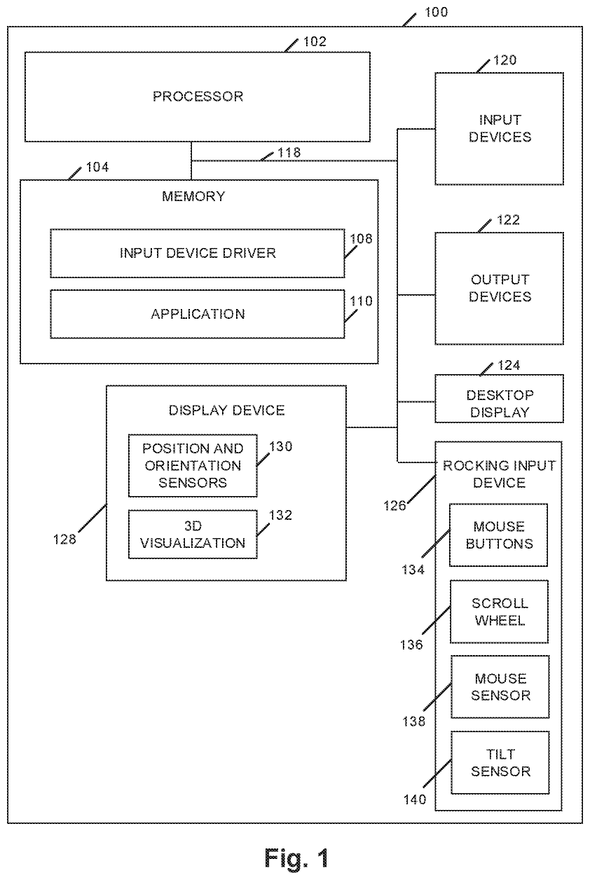

FIG. 1 is a block diagram illustrating a computing system 100 with a rocking input device according to one example. Computing system 100 includes at least one processor 102, a memory 104, input devices 120, output devices 122, desktop display 124, rocking input device 126, and display device 128. In the illustrated example, processor 102, memory 104, input devices 120, output devices 122, desktop display 124, rocking input device 126, and display device 128 are communicatively coupled to each other through communication link 118.

Input devices 120 include a keyboard, mouse, data ports, and/or other suitable devices for inputting information into system 100. Output devices 122 include speakers, data ports, and/or other suitable devices for outputting information from system 100.

Processor 102 includes a central processing unit (CPU) or another suitable processor. In one example, memory 104 stores machine readable instructions executed by processor 102 for operating the system 100. Memory 104 includes any suitable combination of volatile and/or non-volatile memory, such as combinations of Random Access Memory (RAM), Read-Only Memory (ROM), flash memory, and/or other suitable memory. These are examples of non-transitory computer readable storage media. The memory 104 is non-transitory in the sense that it does not encompass a transitory signal but instead is made up of at least one memory component to store machine executable instructions for performing techniques described herein.

Memory 104 stores input device driver module 108 and application module 110. Processor 102 executes instructions of modules 108 and 110 to perform some techniques described herein. Module 108 receives user interaction information from rocking input device 126 indicating a user's interaction with the rocking input device 126. In the illustrated example, rocking input device 126 includes mouse buttons 134, scroll wheel 136, mouse sensor 138, and tilt sensor 140, which all generate a part of the user interaction information provided to module 108. In particular, each of the mouse buttons 134 provides information to indicate when the buttons are pressed and released; the scroll wheel 136 provides information regarding the position or movement of the wheel for controlling scrolling; the mouse sensor 138 provides information regarding 2D translational movement of the rocking input device 126, which may be used to control the 2D translational movement of a displayed cursor; and tilt sensor 140 provides information indicating a current tilt angle of the rocking input device 126 or a tilting portion of the input device 126.

Based on the received user interaction information, module 108 generates user interaction events, and provides the events to application module 110. In one example, application module 110 may generate a 3D visualization 132, such as a VR or AR visualization, which is displayed by display device 128. In another example, application module 110 may generate a 3D CAD visualization, which may be displayed on desktop display 124. It is noted that some or all of the functionality of modules 108 and 110 may be implemented using cloud computing resources.

Display device 128 may be a VR or AR display device, or other 3D output device, and in some examples, may include position and orientation sensors 130. In an example, the display device 128 may be a head-mounted display (HMD) device, such as a VR headset implementing stereoscopic images called stereograms to represent the 3D visualization 132. The 3D visualization 132 may include still images or video images. The VR headset may present the 3D visualization 132 to a user via a number of ocular screens. In an example, the ocular screens are placed in an eyeglass or goggle system allowing a user to view both ocular screens simultaneously. This creates the illusion of a 3D visualization using two individual ocular screens. The position and orientation sensors 130 may be used to detect the position and orientation of the VR headset in 3D space as the VR headset is positioned on the user's head, and the sensors 130 may provide this data to processor 102 such that movement of the VR headset as it sits on the user's head is translated into a change in the point of view within the 3D visualization 132.

Although one example uses a VR headset to present the 3D visualization, other types of environments may also be used. In an example, an AR environment may be used where aspects of the real world are viewable in a visual representation while a 3D object is being drawn within the AR environment. Thus, much like the VR system described herein, an AR system may include a visual presentation provided to a user via a computer screen or a headset including a number of screens, among other types of devices to present the 3D visualization. Thus, the present description contemplates the use of not only a VR environment but an AR environment as well.

In one example, the input device driver module 108 continually identifies particular 2D planes in the 3D visualization 132 based on the respective tilt angles provided by tilt sensor 140. If the tilt angle remains the same, the identified plane remains the same. If the tilt angle changes, the module 108 identifies a new plane corresponding to the new tilt angle. Whenever the mouse sensor 138 detects 2D translational movement, the module 108 causes a corresponding 2D translational movement of a displayed cursor (e.g., displayed in the 3D visualization 132), or in some circumstances, of a selected object in the 3D visualization 132, within the currently identified 2D plane. Although some examples disclosed herein involve movement of a displayed cursor, the movement may also apply to other objects, such as an object selected by the user with the input device 126.

In one example, the various subcomponents or elements of the system 100 may be embodied in a plurality of different systems, where different modules may be grouped or distributed across the plurality of different systems. To achieve its desired functionality, system 100 may include various hardware components. Among these hardware components may be a number of processing devices, a number of data storage devices, a number of peripheral device adapters, and a number of network adapters. These hardware components may be interconnected through the use of a number of busses and/or network connections. The processing devices may include a hardware architecture to retrieve executable code from the data storage devices and execute the executable code. The executable code may, when executed by the processing devices, cause the processing devices to implement at least some of the functionality disclosed herein.

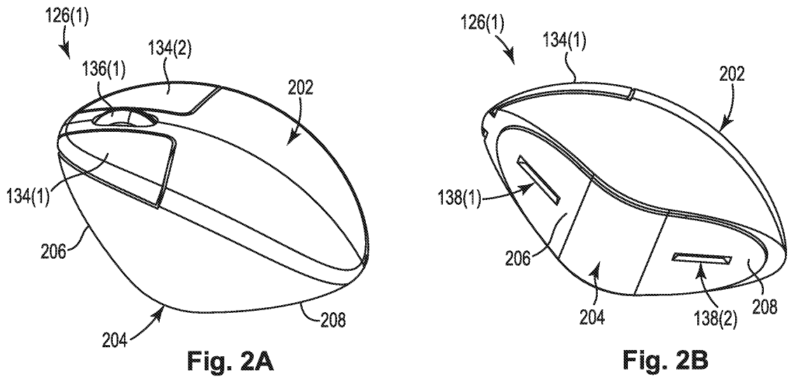

FIG. 2A is a diagram illustrating one view of a two-position rocking input device 126(1) according to one example. FIG. 2B is a diagram illustrating another view of the two-position rocking input device 126(1) shown in FIG. 2A according to one example. The rocking input device 126(1) includes a top surface 202 and a bottom surface 204. Two mouse buttons 134(1) and 134(2) and a scroll wheel 136(1) are positioned on the top surface 202. The bottom surface 204 includes a first substantially flat or planar surface portion 206 and a second substantially flat or planar surface portion 208. The two surface portions 206 and 208 are positioned at an angle with respect to each other (e.g., between about 20 degrees and 90 degrees), such that the input device 126(1) may be rocked forward onto surface portion 206, and may be rocked backward onto surface portion 208. A first mouse sensor 138(1) is positioned within the first surface portion 206, and a second mouse sensor 138(2) is positioned within the second surface portion 208.

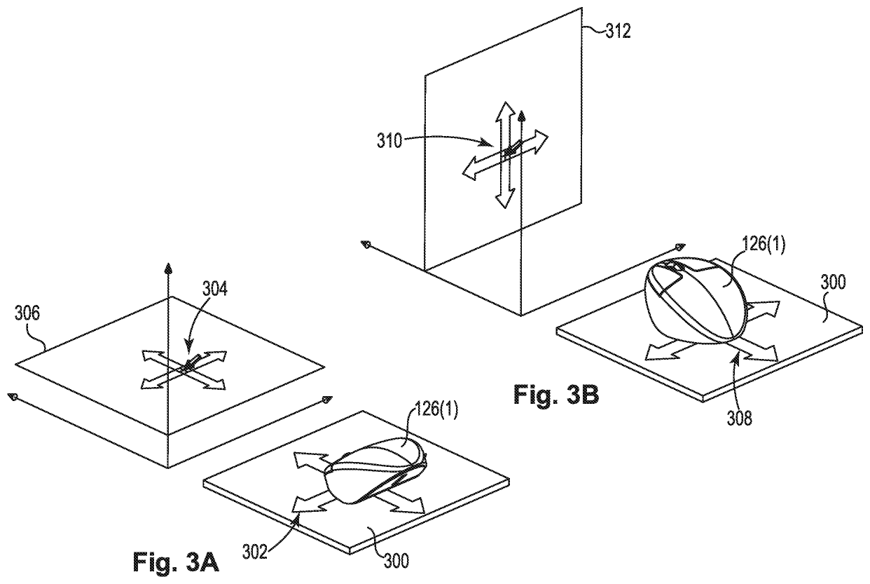

FIGS. 3A and 3B are diagrams illustrating the use of the input device 126(1) shown in FIGS. 2A and 2B to control cursor movement according to one example. Input device 126(1) is a two-position or two-plane example of a rocking input device in that it has two operational states or modes. The first operational state occurs when the input device 126(1) is tilted forward onto the first mouse sensor 138(1), as shown in FIG. 3A, and the second operational state occurs when the input device 126(1) is tilted backward onto the second mouse sensor 138(2), as shown in FIG. 3B. When rocked forward, as shown in FIG. 3A, motion (represented by arrows 302) of the input device 126(1) on a desktop 300 causes a corresponding motion (represented by arrows 304) of the cursor in a horizontal plane 306 in 3D space. When rocked backward, as shown in FIG. 3B, motion (represented by arrows 308) of the input device 126(1) on the desktop 300 causes a corresponding motion (represented by arrows 310) of the cursor in a vertical plane 312 facing the user in 3D space.

In some examples, input device 126(1) includes a tilt sensor 140 (FIG. 1). Various sensor types may be used for the tilt sensor 140 and may be used to distinguish between the two operational states (e.g., a proximity sensor to detect the close presence of a surface, or a gravity-based orientation sensor to determine which way the device 126(1) has been rocked). After the tilt sensor 140 detects the orientation of the input device 126(1) (e.g., tilted forward or tilted backward), the mouse motion may be translated into 3D cursor motion as follows (assuming z is “up”): (1) if the input device 126(1) is tilted backward, Mouse (Δx, Δy)→3D Cursor (Δx, 0, Δy); and (2) if the input device 126(1) is tilted forward, Mouse (Δx, Δy)→3D Cursor (Δx, Δy, 0).

This assignment of orientation to plane of motion makes using the resulting interface reasonably intuitive. The reason for this is that the hand poses assumed by the user in these two operational states are similar to, and suggestive of, the poses that would be involved when holding a flat device against a horizontal and then a vertical surface. The input device 126(1) may be weighted or otherwise designed to default to, for example, the horizontal plane mode unless actively rocked into the other mode. Additional bottom surface portions with corresponding mouse sensors may be added to input device 126(1) to allow motion in additional planes. In one example of input device 126(1), any movement between two arbitrary points in 3D space will be broken up into at least two motions (i.e., a horizontal one and a vertical one).

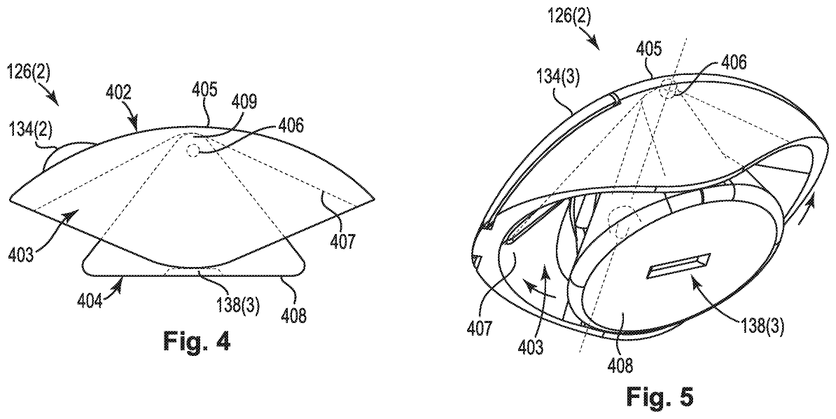

FIG. 4 is a diagram illustrating one view of a multi-plane rocking input device 126(2) according to one example. FIG. 5 is a diagram illustrating another view of the multi-plane rocking input device 126(2) shown in FIG. 4 according to one example. The rocking input device 126(2) includes an outer shell 402 and an inner base 404. The outer shell 402 includes a top surface 405 and a bottom surface 407. A mouse button 134(3) is positioned on the top surface 405 of the outer shell 402. The bottom surface 407 of the outer shell 402 defines a cavity 403. The inner base 404 has a substantially conical shape, and includes a substantially flat or planar bottom surface 408 having a circular periphery. A mouse sensor 138(3) is positioned within the bottom surface 408 of the inner base 404.

A top portion 409 of the inner base 404 along with a majority of the height of the inner base 404 is positioned within the cavity 403 of outer shell 402. The outer shell 402 may be rocked forward and backward on the inner base 404 about a pivot point 406 through a range of tilt angles. These tilt angles may be mapped to the rotation of a plane of cursor motion between +90 degrees and −90 degrees from horizontal. Regardless of the tilt angle of the outer shell 402, the bottom surface 408 of the inner base 404 remains flat against a desktop surface, and may be moved along the desktop surface, which results in the mouse sensor 138(3) generating 2D translation data indicative of the movement. The tilt can be changed dynamically while the input device 126(2) is in motion along the desktop surface.

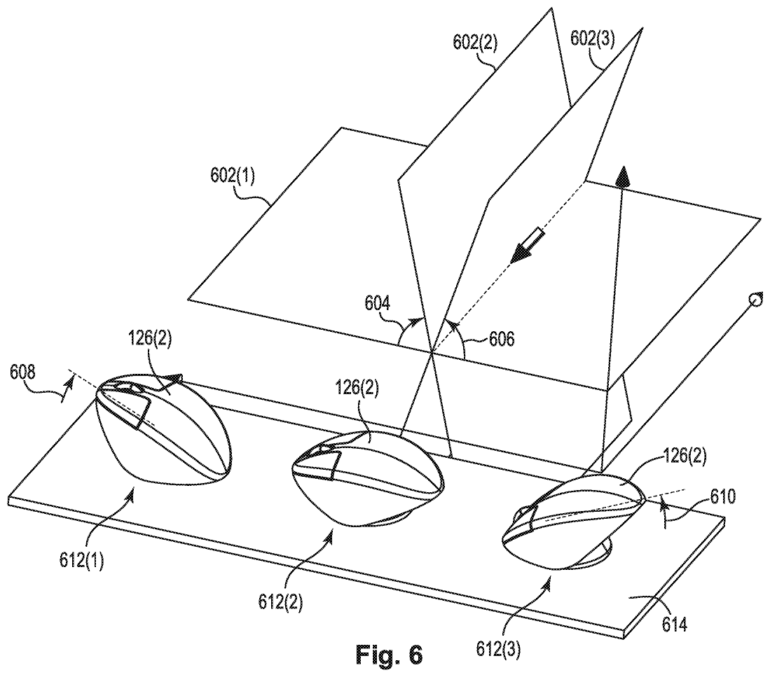

FIG. 6 is a diagram illustrating the use of the input device 126(2) shown in FIGS. 4 and 5 to control cursor movement according to one example. If the outer shell 402 is tilted neither forward nor backward, as shown at position 612(2), any cursor motion will be in a horizontal plane 602(1). As the outer shell 402 is tilted backwards by a tilt angle 608, as shown at position 612(1), the plane of cursor motion tilts up towards the user, as indicated by plane 602(2) tilted at an angle 604. As the outer shell 402 is tilted forwards by a tilt angle 610, as shown at position 612(3), the plane of cursor motion tilts down away from the user, as indicated by plane 602(3) tilted at an angle 606. Translational motion of the input device 126(2) on a desktop 614 causes a corresponding motion of a cursor in the currently selected plane (e.g., plane 602(1), 602(2), or 602(3)).

Input device 126(2) includes a tilt sensor 140 (FIG. 1). Various sensor types (e.g., gravity sensor, rotational encoder at pivot point, etc.) may be used for the tilt sensor 140 and may be used to identify the tilt angle of the outer shell 402. After the tilt sensor 140 detects the tilt angle, θ, of the outer shell 402, the tilt angle is multiplied by a scale factor, S, to get an angle between +90 degrees and −90 degrees, and the mouse motion may be translated into 3D cursor motion as follows (assuming z is “up”): Mouse (Δx, Δy)→3D Cursor (Δx, Δy cos(Sθ), Δy sin(Sθ)).

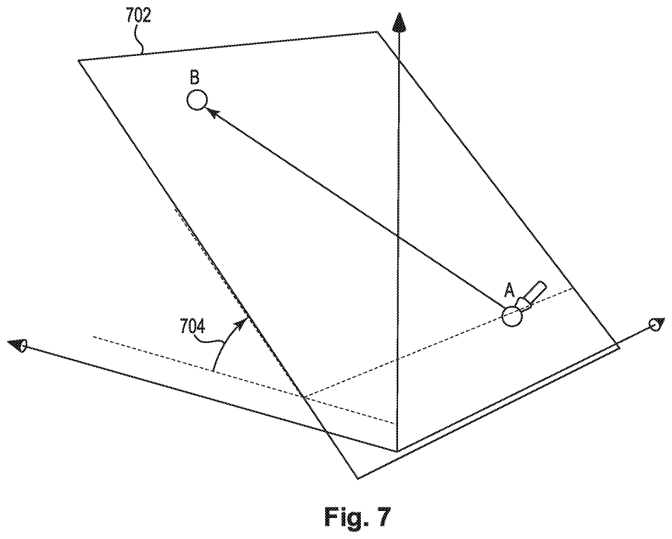

FIG. 7 is a diagram illustrating the use of the input device 126(2) shown in FIGS. 4 and 5 to control cursor movement according to another example. Because the motion between any two points in 3D space can be achieved entirely within a single plane 702 tilted at an angle 704 to include the two points, this enables the user to use the input device 126(2) to move the cursor from any point A to any other point B in one motion. Additionally, since any arbitrarily convoluted mouse trajectory in 3D space can be broken down into a series of straight line motions, the input device 126(2), using the dynamically adjustable tilt described above, enables the user to move the cursor along almost any trajectory of their choosing in a single motion. Trajectories that include a change from, for example, +89 degrees to −89 degrees, or vice versa, will involve the user rocking the outer shell 402 from one extreme to the other and reverse mouse direction.

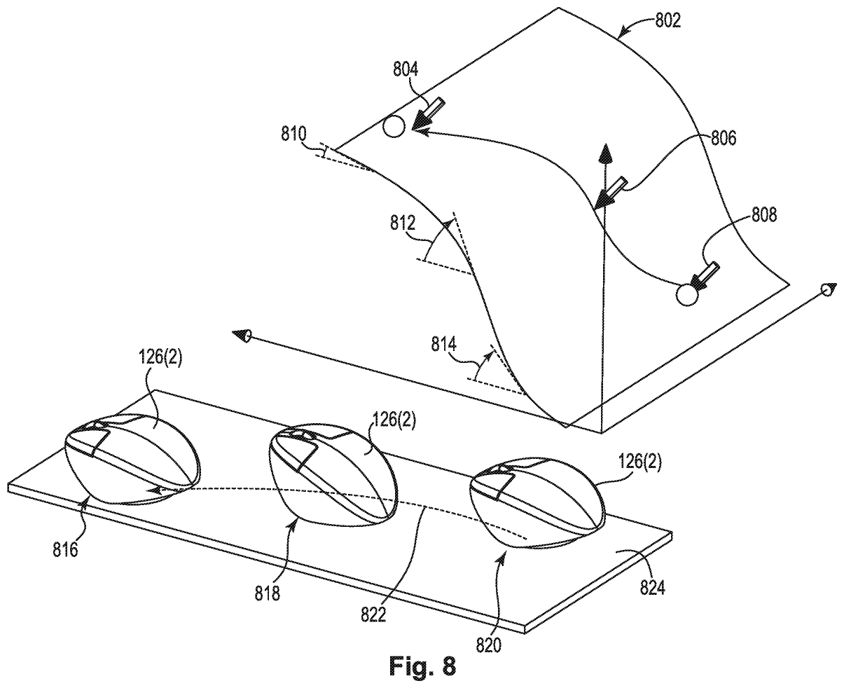

FIG. 8 is a diagram illustrating the use of the input device 126(2) shown in FIGS. 4 and 5 to control cursor movement according to yet another example. The dynamically adjustable tilt of input device 126(2) allows a user to more intuitively control the cursor motion as the user can continuously adjust the 3D motion of the cursor as it nears the desired end-point. This means that it is not necessary for the user to first select the correct motion plane angle, and then move the mouse. Instead, the user can start moving the mouse with a rough approximation of the correct motion plane angle, and continually refine that angle “on the fly” as the motion progresses.

For example, as shown in FIG. 8, input device 126(2) begins at position 820, and is moved along desktop 824 to positions 818 and then 816, as indicated by arrow 822. During the translational movement represented by arrow 822, the tilt of the input device 126(2) is continually changed. At starting position 820, the input device 126(2) is tilted slightly backward, resulting in a plane of motion at cursor position 808 (point A) that is at an angle 814 with respect to a horizontal plane. As the input device 126(2) is moved along the desktop 824 from position 820 to position 818, the backward tilt of the input device 126(2) is gradually increased, resulting in a plane of motion at cursor position 806 that is at an angle 812 with respect to a horizontal plane. As the input device 126(2) is moved along the desktop 824 from position 818 to position 816, the backward tilt of the input device 126(2) is gradually decreased, resulting in a plane of motion at cursor position 804 (point B) that is at an angle 810 with respect to a horizontal plane. Thus, the gradually changing plane of motion essentially results in a curved surface of motion 802 from point A to point B.

Input device 126(2) may include a spring loaded detent at the horizontal orientation, and may incorporate a release button (e.g., a release button on the side of the device 126(2) that may be depressed to enable the outer shell 402 to rock freely). The modules 108 and 110 (FIG. 1) may be designed to show a graphic indicating the current orientation of the plane of motion, and/or where that plane intersects other objects in the 3D space.

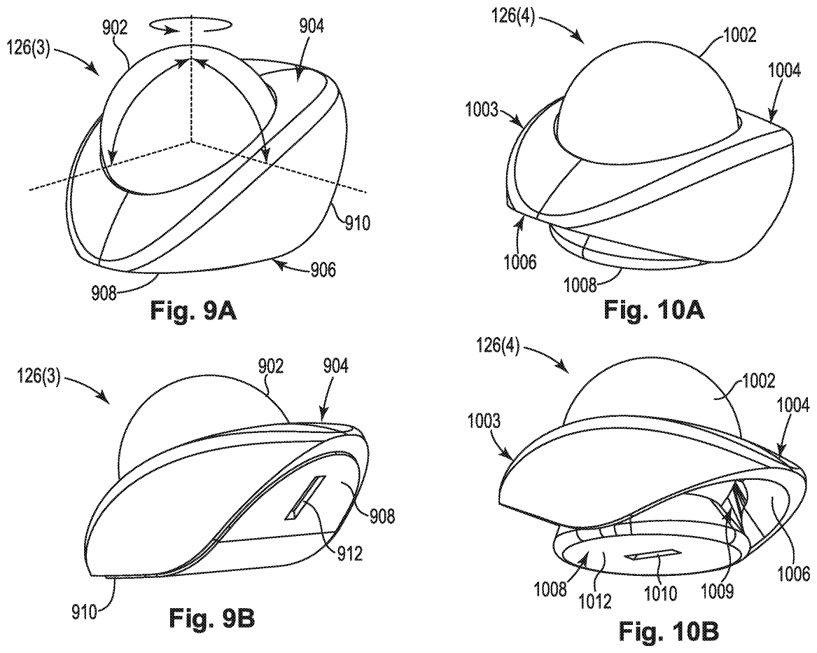

Although some examples disclosed herein are directed to a rocking mouse-type input device, other examples may include any device that uses a mouse sensor to provide motion input in 2D, which may then be modified to provide input in 3D using techniques described herein. For example, a 6DOF controller may include a 3DOF trackball-like sphere to control orientation in three dimensions, a mouse-like base with a mouse sensor to control translation in the two horizontal dimensions, and an additional control (e.g., a thumbwheel) to control translation in the vertical direction. The 3DOF spherical orientation controller in such a device may be combined with a rocking mouse 3DOF translation controller to yield a 6DOF control device that does not use an additional controller for vertical translation, as described in further detail below with reference to FIGS. 9A and 9B.

FIG. 9A is a diagram illustrating one view of a 6DOF two-position rocking input device 126(3) according to one example. FIG. 9B is a diagram illustrating another view of the 6DOF two-position rocking input device 126(3) shown in FIG. 9A according to one example. The rocking input device 126(3) includes a top surface 904 and a bottom surface 906. A 3DOF spherical orientation controller 902 extends out from the top surface 904. The bottom surface 906 includes a first substantially flat or planar surface portion 908 and a second substantially flat or planar surface portion 910. The two surface portions 908 and 910 are positioned at an angle with respect to each other (e.g., between about 20 degrees and 90 degrees), such that the input device 126(3) may be rocked forward onto surface portion 908, and may be rocked backward onto surface portion 910. A first mouse sensor 912 is positioned within the first surface portion 908, and a second mouse sensor (not visible) is positioned within the second surface portion 910.

Input device 126(3) is a two-position or two-plane example of a rocking input device in that it has two operational states or modes. The first operational state occurs when the input device 126(3) is tilted forward onto the first mouse sensor 912, as shown in FIG. 9A, and the second operational state occurs when the input device 126(3) is tilted backward onto the second mouse sensor, as shown in FIG. 9B. When rocked forward, motion of the input device 126(3) on a desktop causes a corresponding motion of the cursor in a horizontal plane. When rocked backward, motion of the input device 126(3) on the desktop causes a corresponding motion of the cursor in a vertical plane facing the user.

In some examples, input device 126(3) includes a tilt sensor 140 (FIG. 1). Various sensor types may be used for the tilt sensor 140 and may be used to distinguish between the two operational states (e.g., a proximity sensor to detect the close presence of a surface, or a gravity-based orientation sensor to determine which way the device 126(3) has been rocked).

Note that the system 100 will take into account the tilt of the input device 126(3) when determining the axes of rotation of the spherical controller 902, so that, for example, the vertical axis of the spherical controller 902 (rotation about which translates into yaw) is up, no matter how the input device 126(3) is rocked.

FIG. 10A is a diagram illustrating one view of a 6DOF multi-plane rocking input device 126(4) according to one example. FIG. 10B is a diagram illustrating another view of the 6DOF multi-plane rocking input device 126(4) shown in FIG. 10A according to one example. The rocking input device 126(4) includes a 3DOF spherical orientation controller 1002, an outer shell 1003, and an inner base 1008. The outer shell 1003 includes a top surface 1004 and a bottom surface 1006. The spherical controller 1002 is movably mounted on a top end of the base 1008, and extends out from the top surface 1004 of the outer shell 1003. The bottom surface 1006 of the outer shell 1003 defines a cavity 1009. The inner base 1008 has a substantially flat or planar bottom surface 1012 having a circular periphery. A mouse sensor 1010 is positioned within the bottom surface 1012 of the inner base 1008.

A top portion of the inner base 1008 along with a majority of the height of the inner base 1008 is positioned within the cavity 1009 of outer shell 1003. The outer shell 1003 may be rocked forward and backward on the inner base 1008 about a pivot point through a range of tilt angles. These tilt angles may be mapped to the rotation of a plane of cursor motion between +90 degrees and −90 degrees from horizontal. Regardless of the tilt angle of the outer shell 1003, the bottom surface 1012 of the inner base 1008 remains flat against a desktop surface, and may be moved along the desktop surface, which results in the mouse sensor 1010 generating 2D translation data indicative of the movement. The tilt can be changed dynamically while the input device 126(4) is in motion along the desktop surface.

If the outer shell 1003 is tilted neither forward nor backward, any cursor motion will be in a horizontal plane. As the outer shell 1003 is tilted backward, the plane of cursor motion tilts up towards the user. As the outer shell 1003 is tilted forwards, the plane of cursor motion tilts down away from the user. Translational motion of the input device 126(4) on a desktop causes a corresponding motion of a cursor in the currently selected plane. Input device 126(4) includes a tilt sensor 140 (FIG. 1). Various sensor types may be used for the tilt sensor 140 and may be used to identify the tilt angle of the outer shell 1003.

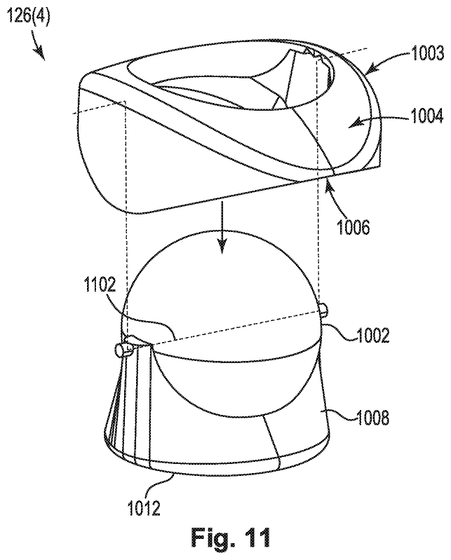

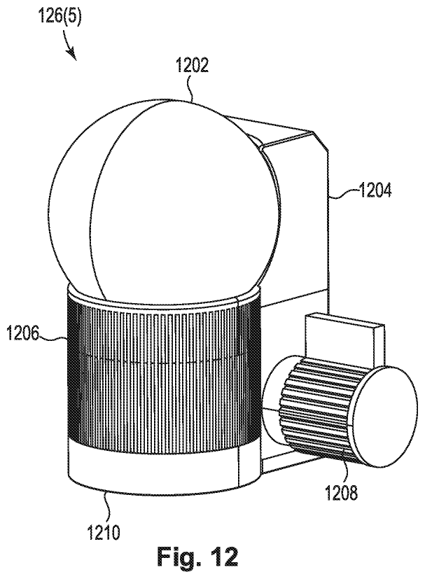

FIG. 11 is a diagram illustrating the 6DOF multi-plane rocking input device 126(4) shown in FIGS. 10A and 10B with the outer shell 1003 removed according to one example. The spherical controller 1002 is retained and tracked by the base 1008, which is typically positioned flat on a desktop. The base 1008 may include optical rotation sensors to track movement of the spherical controller 1002, and may include the tilt sensor 140 (FIG. 1). The outer shell 1003, when added to the input device 126(4), rotates about an axis 1102 that coincides with the center of the spherical controller 1002, so no additional clearance is provided around the sphere to allow it to rock freely.

As an alternative to tilting the entire input device, some examples may involve tilting a portion of the input device, such as a paddle-like lever on one or both sides of the body of the input device. FIG. 12 is a diagram illustrating an input device 126(5) with a paddle-like lever 1208 for identifying a plane for cursor motion according to one example. The input device 126(5) includes base portions 1204 and 1210, wheel 1206, 3DOF spherical orientation controller 1202, and paddle-like lever 1208. Input device 126(5) may include sensors for detecting movement of the 3DOF spherical orientation controller 1202, wheel 1206, lever 1208, as well as 2D translational movement of the input device 126(5) itself along a surface. All of these movements may be used to control movement of a displayed cursor or other displayed object, as well as to perform other manipulations of displayed information.

The lever 1208 is rotatably mounted on a side of the base portion 1204, and may be rotated forward and backward through a range of tilt angles. These tilt angles may be mapped to the rotation of a plane of cursor motion between +90 degrees and −90 degrees from horizontal. Alternatively, the lever may only select between motion in a horizontal plane and motion in a vertical plane as shown in FIG. 3, depending on whether the lever is down or up. Thus, the lever 1208 may be used to select a plane of cursor motion, and translational motion of the input device 126(5) on a desktop causes a corresponding motion of a cursor in the currently selected plane. A tilt lever, such as lever 1208, may also be added to other types of input devices, such as any of the input devices disclosed herein, or a traditional mouse input device (e.g., added to the side of the mouse and operated as a thumb-controlled lever).

Techniques described herein may also be applied to other devices that operate in two dimensions and can be tilted, such as a pen input device that incorporates a tilt sensor. Techniques described herein may also be applied to input devices traditionally used in three dimensions, such as VR controllers, to create versions that do not need to be lifted from the desktop. For example, a VR controller could be removably inserted into a slot in the top of the input device 126(2) shown in FIGS. 4 and 5. Note however that such an implementation may not allow 6DOF control in 3D space, as the system is essentially using the pitch orientation of the VR controller to control translation in a vertical direction. Joystick-like control of yaw and roll would still be available, however, with appropriate pivots and sensors. Such a controller may be useful for applications where controlling 3DOF orientation is less important than allowing the user to rest their hands on a desktop for extended usage.

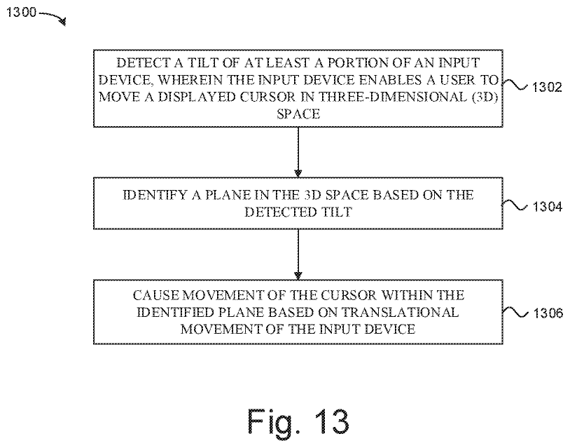

One example of the present disclosure is directed to a method of controlling movement of a displayed cursor with an input device. FIG. 13 is a flow diagram illustrating a method 1300 of controlling movement of a displayed cursor with an input device according to one example. At 1302 in method 1300, a tilt of at least a portion of an input device is detected, wherein the input device enables a user to move a displayed cursor in three-dimensional (3D) space. At 1304, a plane in the 3D space is identified based on the detected tilt. At 1306, movement of the cursor is caused within the identified plane based on translational movement of the input device.

The tilt in method 1300 may be limited to a forward tilt and a backward tilt. The method 1300 may further include identifying a horizontal plane in the 3D space when the detected tilt is a forward tilt, and identifying a vertical plane in the 3D space when the detected tilt is a backward tilt. The detected tilt in method 1300 may include a tilt angle, and the method 1300 may further include mapping the tilt angle to a corresponding plane in the 3D space. The method 1300 may further include displaying a graphic indicating an orientation of the identified plane.

Another example of the present disclosure is directed to a system, which includes an input device to enable a user to move a displayed cursor in three-dimensional (3D) space, wherein the input device includes a mouse sensor to sense two-dimensional (2D) translational movement of the input device, and a tilt sensor to sense a tilt of at least a portion of the input device. The system includes a controller to identify a plane in the 3D space based on the sensed tilt, and cause movement of the cursor within the identified plane based on the sensed 2D translational movement of the input device.

The input device of the system may include a bottom surface including a first substantially flat surface portion and a second substantially flat surface portion, wherein the first and second surface portions are positioned at an angle with respect to each other such that the input device may be tilted forward onto the first surface portion and tilted backward onto the second surface portion. The mouse sensor may be positioned within the first surface portion, and the input device may include a second mouse sensor positioned within the second surface portion. The input device may further include a three degree of freedom (3DOF) spherical orientation controller. The controller may cause movement of the cursor within a horizontal plane when the input device is tilted forward onto the first surface portion, and the controller may cause movement of the cursor within a vertical plane when the input device is tilted backward onto the second surface portion.

The input device of the system may include an outer shell and an inner base, wherein the outer shell tilts forward and backward on the inner base, and wherein the tilt sensor senses the tilt of the outer shell. The outer shell may include a mouse button positioned on a top surface of the outer shell, and the mouse sensor may be positioned within a bottom surface of the inner base. The input device may further include a three degree of freedom (3DOF) spherical orientation controller.

Yet another example of the present disclosure is directed to an input device for a computer system, which includes a tilt sensor to detect a tilt of at least a portion of the input device and output corresponding tilt data to the computer system, wherein the tilt data enables the computer system to identify a plane in three-dimensional (3D) space. The input device further includes a mouse sensor to detect two-dimensional (2D) translational movement of the input device and output corresponding movement data to the computer system to cause movement of a displayed cursor within the identified plane in the 3D space. The input device may include a three degree of freedom (3DOF) spherical orientation controller.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
detecting a tilt of at least a portion of an input device, wherein the input device enables a user to move a displayed cursor in three-dimensional (3D) space;
identifying a plane in the 3D space based on the detected tilt; and
causing movement of the cursor within the identified plane based on translational movement of the input device.

2. The method of claim 1, wherein the tilt is limited to a forward tilt and a backward tilt.

3. The method of claim 2, and further comprising:
identifying a horizontal plane in the 3D space when the detected tilt is a forward tilt; and
identifying a vertical plane in the 3D space when the detected tilt is a backward tilt.

4. The method of claim 1, wherein the detected tilt includes a tilt angle, and wherein the method further comprises:
mapping the tilt angle to a corresponding plane in the 3D space.

5. The method of claim 1, and further comprising:
displaying a graphic indicating an orientation of the identified plane.

6. A system, comprising:
an input device to enable a user to move a displayed cursor in three-dimensional (3D) space, wherein the input device includes a mouse sensor to sense two-dimensional (2D) translational movement of the input device, and a tilt sensor to sense a tilt of at least a portion of the input device; and
a controller to identify a plane in the 3D space based on the sensed tilt, and cause movement of the cursor within the identified plane based on the sensed 2D translational movement of the input device.

7. The system of claim 6, wherein the input device includes a bottom surface including a first substantially flat surface portion and a second substantially flat surface portion, wherein the first and second surface portions are positioned at an angle with respect to each other such that the input device may be tilted forward onto the first surface portion and tilted backward onto the second surface portion.

8. The system of claim 7, wherein the mouse sensor is positioned within the first surface portion, and wherein the input device includes a second mouse sensor positioned within the second surface portion.

9. The system of claim 8, wherein the input device further includes a three degree of freedom (3DOF) spherical orientation controller.

10. The system of claim 7, wherein the controller causes movement of the cursor within a horizontal plane when the input device is tilted forward onto the first surface portion, and wherein the controller causes movement of the cursor within a vertical plane when the input device is tilted backward onto the second surface portion.

11. The system of claim 6, wherein the input device includes an outer shell and an inner base, wherein the outer shell tilts forward and backward on the inner base, and wherein the tilt sensor senses the tilt of the outer shell.

12. The system of claim 11, wherein the outer shell includes a mouse button positioned on a top surface of the outer shell, and wherein the mouse sensor is positioned within a bottom surface of the inner base.

13. The system of claim 11, wherein the input device further includes a three degree of freedom (3DOF) spherical orientation controller.

14. An input device for a computer system, comprising:
a tilt sensor to detect a tilt of at least a portion of the input device and output corresponding tilt data to the computer system, wherein the tilt data enables the computer system to identify a plane in three-dimensional (3D) space; and
a mouse sensor to detect two-dimensional (2D) translational movement of the input device and output corresponding movement data to the computer system to cause movement of a displayed cursor within the identified plane in the 3D space.

15. The input device of claim 14, and further comprising:
a three degree of freedom (3DOF) spherical orientation controller.
